(19) United States
(12) Patent Application Publication
(10) Pub. No.: US 2007/0125217 A1
(43) Pub. Date: Jun. 7, 2007

(54) Tool for cutting hollow sections

(75) Inventor: Lionel Marcon, Montmorency (FR)

Correspondence Address: LEYDIG VOIT & MAYER, LTD, 700 THIRTEENTH ST. NW, SUITE 300, WASHINGTON, DC, 20005-3960, US

(73) Assignee: Etablissements Pierre Grehal Et Cie SA, Saint-Brice-Sous-Foret (FR)

(21) Appl. No.: 10/542,453

(22) PCT Filed: Apr. 8, 2005
(86) PCT No.: PCT/FR05/00865

§ 371 Date: Oct. 3, 2006

(30) Foreign Application Priority Data
Apr. 9, 2004 (FR) 0403781

(51) Int. Cl. B26D 1/00

(52) U.S. Cl. 83/651

(57) ABSTRACT

The invention relates to a tool for cutting hollow plastic articles comprising a base and a blade movably mounted on a support. The support is fixed to the base and the blade is displaceable between an open position for receiving an article between the base and the blade and a closed position after cutting. The base includes an anvil having a slot for receiving a part of the blade in the closed position. The support includes a calibrated guide which ensures rectilinear displacement of the blade between the open and closed positions.

### FIELD OF THE INVENTION

The invention relates to a cutting tool for cutting hollow plastic sections.

### BACKGROUND

In numerous cases, and particularly in the case of an electrical installation, it is necessary to be able to cut hollow plastic sections very precisely and cleanly. Furthermore, when such hollow sections are to be cut in the context of a new installation, it is a matter of being able to cut a large quantity of these sections in a relatively short time but nevertheless with the required precision. In effect, when installing cables projecting from a wall front or when embedding them in a wall front but in an easily accessible manner, one uses sheaths having a rectangular cross section and formed by a U-shaped section, possibly provided with one or two internal separation walls, forming three of the four walls of the hollow section, and a cover attached to the U-shaped section by hinges or entirely removable, forming the fourth wall of the hollow section. However, cylindrical sheaths of different diameters are also used for electrical installations. Under the installation conditions stated above, it proves insufficient from the standpoint of precise cutting as well as from the standpoint of cutting speed to wish to cut such hollow sections using a saw or cutting pliers resembling pruning shears.

Furthermore, since such hollow sections are used mainly in an electrical installation as cable sheaths, it is a matter of being able to cut hollow profiles with different cross sections and lengths and particularly with different bevel angles in addition to a right angle.

The aim of the invention is to propose a cutting tool for cutting hollow plastic sections, which unites the advantage of rapid and precise cutting with that of cutting hollow sections of different dimensions.

### SUMMARY OF THE INVENTION

The aim of the invention is attained with a cutting tool for cutting hollow plastic sections, which has a base and a blade mounted so as to be mobile on a support attached to the base and enabling one to move the blade between an open position for receiving, between the base and the blade, a section that is to be cut, and a closed position at the end of the cutting operation.

According to the invention, the base supports an anvil provided with a groove configured so as to receive a part of the blade when it is in closed position, and the support is provided with a calibrated guide means ensuring a linear movement of the blade between the open position and the closed position.

This design of the invention makes it possible to place the section that is to be cut on the anvil with any orientation of the hollow section with respect to the orientation of the blade. When the section that is to be cut is a sheath with a rectangular cross section, it can be placed on any of the lateral walls of the hollow section. Thus, clean and rapid cuts are obtained for right angle cuts as well as for beveled cuts. Furthermore, thanks to the linear movement of the blade, the section that is to be cut does not risk being expelled by the blade at the beginning of cutting. And this is valid when the section is supported by two adjacent walls, the situation of the right angle cut, as well as when the section is supported only by the side by which it rests on the anvil, which corresponds to beveled cutting.

The cutting tool of the invention is designed so that it can be used as a hand tool and as a tool in fixed position. For this purpose, the cutting tool of the invention advantageously has at least one first lever mounted so as to pivot in the support of the tool. This first lever is intended to cooperate with the blade so as to move it at least from the open position to the closed position.

According to a preferred embodiment, besides having the first lever, the tool of the invention also has a second lever, the first and second levers being articulated together on a pivot shaft making it possible both to grasp the tool and to make the blade move at least from the open position to the closed position. While the first and second levers can both be mounted so as to pivot on the support of the cutting tool, it seems preferable for the first lever to be mounted both so as to pivot with respect to the second lever and to pivot with respect to the support and for the second lever to be mounted fixed with respect to the support of the tool.

When the cutting tool of the invention is executed only for cutting sections of small dimensions, for example, for sections with a rectangular cross section of 10 millimeters by 20 millimeters, the movement of the blade using the first lever can be brought about in a simple manner, particularly by an articulated connection between the first lever and the blade. The blade is in that case mounted on a rod, for example, a metallic rod with a circular cross section, to which a corresponding end of the first lever is attached. This design makes it possible to move the blade using the first lever from the open position to the closed position as well as from the closed position to the open position.

However, in order to draw the most benefit from the cutting tool of the invention, its dimensions will be determined so that it is possible also to cut hollow sections with relatively large dimensions, for example, sections of which the rectangular cross section is on the order of 25 millimeters by 30 millimeters or even 45 millimeters by 70 millimeters. This then implies a rather long course of travel of the blade. For this reason, it is preferable for the blade to be mounted on a rack and selectively actuated by the first lever using a mechanism such as that described in the document FR-A-2796977, for example. This mechanism has a driving pawl mounted so as to swing around a first transverse shaft attached to the first lever and transmit to the rack, in the direction of advance from the open position to the closed position of the blade, a translation movement connected with the pivoting movement of the first lever, and a holding pawl, mounted so as to swing around a second transverse shaft, for prohibiting movement of the rack in the reverse direction from the direction of advance.

The movement of the blade from the closed position to the open position, just like a movement of the blade from the open position to a partially closed position, is obtained by a turning of the rack around its longitudinal axis and thus removing the side of the rack with the notches from the radius of action of the driving pawl, followed by a translation of the rack in one axial direction or the other.

Furthermore, the blade is advantageously provided with two successive cutting edges forming a peak between them, enclosing an obtuse angle of approximately 110 to 150 degrees. A preferred angle is 130 degrees.

The blade can be formed symmetrically, the peak formed by the two cutting edges of the blade then being positioned on a central line of the blade.

However, it is also conceivable for the blade to be formed asymmetrically, that is to say that the two cutting edges form different angles with the direction of translation of the blade and thus form a peak outside the longitudinal axis of symmetry of the blade.

The linear movement of the blade, that is to say a translation movement according to a longitudinal axis of the rod or rack to which the blade is attached, is ensured by a calibrated guide formed inside the support of the tool. When the support is made out of metal, one advantageously inserts a tubular element made out of plastic material, precisely calibrated with regard to its interior diameter in order to avoid play between the rod or rack and the tubular element, in which the rod or rack slides during the movements of the blade.

If, in contrast, the support is made out of plastic material, one can forgo an insert. In effect, in order to avoid gripping between the support and the rod or rack, the two pieces intended for relative motion with respect to one another must be made out of materials of different natures or at least with different hardnesses. Thus, when the rod or rack is made of metal, one will use an insert made of plastic only when the support is also made of metal.

The cutting tool of the invention can also have one or another of the following characteristics considered separately or in any technically possible combination:
the base is provided with stops mounted on both sides of the base and configured in such a way as to enable one to position the section that is to be cut in a precise angular position with respect to the orientation of the blade in order to obtain a beveled cutting of the section;
the anvil is provided with stops arranged on both sides of the base and configured in such a way as to enable one to position the section that is to be cut in a precise angular position with respect to the orientation of the blade in order to obtain a beveled cutting of the section, the anvil and the stops forming a removable unit configured for a particular bevel angle and interchangeable with other interchangeable units configured for other particular bevel angles;
when the anvil provided with stops forms a removable unit, this unit can be mounted on the base using a catching mechanism for ensuring rapid replacement; however, attachments using clips or bolts or screws are also conceivable;
the anvil is provided with stops arranged on both sides of the base and configured in such a way as to enable one to position the section that is to be cut in a precise angular position with respect to the orientation of the blade in order to obtain a beveled cutting of the section, the stops forming a removable unit configured for a particular bevel angle and interchangeable with other interchangeable units configured for other particular bevel angles; the anvil and the stops are provided with passage holes enabling one to attach the stops on the anvil by a bolt, by a screw with a wing nut or by other means of attachment enabling one to attach and remove the stop unit rapidly;
as a variant, each of the stops forming a removable unit is provided with an oblong hole enabling one to attach the stop unit in at least two different positions, a work position and a retracted position, without the need to undo the attachment entirely;
the base sticks out transversely with respect to the longitudinal extent of the support of the tool, at least toward one side or the other of the tool; this arrangement of the invention enables one to use the same tool as a hand tool and as a tool mounted fixed on a set support; the projection enables one to grasp the tool with pliers or a clamp or another appropriate tool and to mount it on the edge of a table or on the edge of the upper plate of a work bench; as a variant, the base can also be provided with perforations enabling one to attach the tool on a work bench or a board using screws; the possibility of attaching the tool on a plank of wood is particularly appreciated when the tool is used on loose ground, where the plank of wood first enables one to give the tool a stable bearing surface, and it also enables one to attach the tool, for example, to nail or screw it, on this bearing surface;
the base has two crosspieces oriented essentially perpendicularly with respect to the orientation of the blade, these crosspieces intended to give the tool a secure seating, even when the tool is configured for cuts of rather large dimensions; the size of the two crosspieces is advantageously chosen according to the foreseen use of the tool, namely as portable tool or as tool intended for attachment to a work surface; for the latter use, the crosspieces can be provided with holes;
the base has one crosspiece oriented essentially perpendicularly with respect to the orientation of the blade and an extension extending according to the orientation of the blade, the crosspiece being arranged on the side of the levers of the tool and the extension extending beyond the anvil away from the crosspiece, the crosspiece and the extension thus forming a tripod intended for giving the tool a seating that is even more secure than two crosspieces;
the tool is provided with a retractable lever intended for making the blade move from the open position to the closed position; the retractable lever is, for example, in the form of two or more parts connected together by hinges so that the lever can be folded over itself during transport of the tool or when the tool is being stored; as a variant, the lever is in the form of two or more parts that can be dissociated, for example, that are capable of nesting in one another;
the tool has a structure made by plastic injection reinforced by inserts made of hardened steel.

### BRIEF DESCRIPTION OF DRAWING FIGURES

Other characteristics and advantages of the invention will emerge from the description hereafter of an embodiment of the cutting tool of the invention. This description is given in reference to drawings in which

FIG. 1 shows the cutting tool according to a first embodiment of the invention in the form of a side view,

FIG. 2 shows the removable anvil of the tool of FIG. 1 in the form of a perspective view,

FIG. 3 shows the removable anvil of FIG. 2 in the form of a perspective view, detached from the base of the tool,

FIG. 4 shows the cutting tool according to a second embodiment of the invention in the form of a perspective view,

FIG. 5 shows the anvil of the tool of FIG. 4 with stops in retracted position,

FIG. 6 shows the anvil of the tool of FIG. 4 with stops in work position,

FIG. 7 shows the means of locking of the tool of FIG. 4,

FIG. 8 shows the tool of FIG. 4 at the beginning of cutting of a rectangular section,

FIG. 9 shows the tool of FIG. 4 at the beginning of cutting of a tubular round section, and

FIG. 10 shows a variant of the tool of FIG. 4.

### DETAILED DESCRIPTION

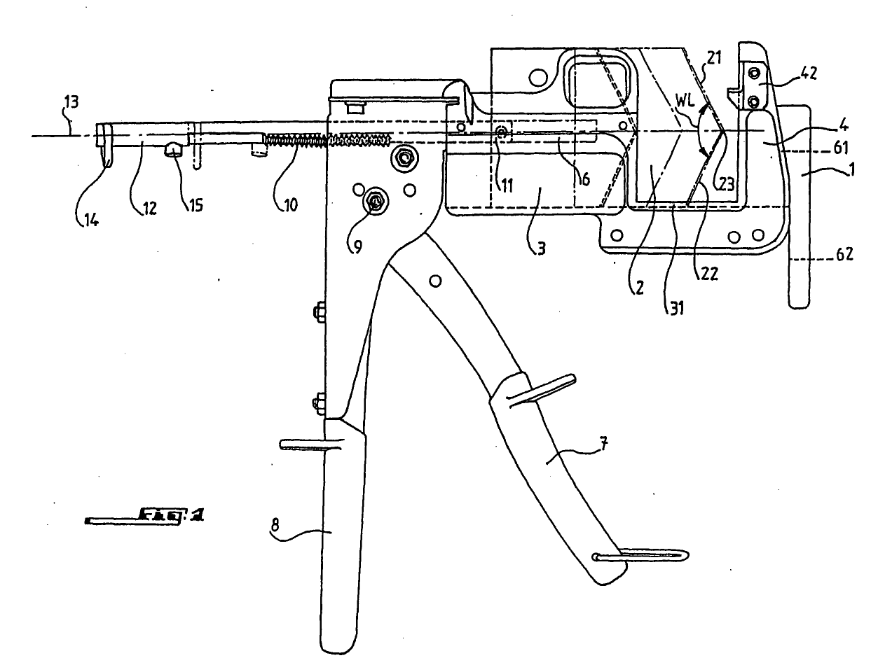

The cutting tool according to a first embodiment of the invention, as represented in FIG. 1, has base 1 and blade 2 mounted so as to be mobile on structure or support 3 attached to base 1 and enabling one to move blade 2 in axial translation between an open position for receiving, between base 1 and blade 2, a section that is to be cut, and a closed position at the end of the cutting operation.

Base 1 supports anvil 4 provided with groove 5 configured for receiving a part of blade 2 when it is in closed position. Support 3 is provided with calibrated guide means 6 in the form of a hollow cylindrical insert ensuring a linear movement of blade 2 between the open position and the closed position. Support 3 also has groove 31 oriented in the direction of translation of blade 2. Groove 31 receives, in a sliding manner, a corresponding edge of blade 2 during its movements in order to prevent any effect of rotation of blade 2 around its own longitudinal axis.

While support 3 is represented in FIG. 1 in a configuration suitable rather for cutting of sections with a rectangular cross section, it is also conceivable, without diverging from the principle of the present invention, to configure support 3 for the cutting of cylindrical sections. This can be done essentially in two ways. According to the first way, support 3 and anvil 4 in the version represented in FIG. 1, that is to say with a rectangular opening for receiving the section to be cut, are replaced by a support and an anvil that together form a semi-circular opening or an opening that at least has partially rounded opposite surfaces. For a user of the tool to be able to make such a modification easily and, above all, on a number of occasions in both directions, the support must be designed as a modular element.

According to a second way of adapting the tool alternatively to the cutting of a section with a rectangular cross section or to the cutting of a section with a circular cross section, or more generally with a round cross section, an insert is provided whose exterior shape and dimensions correspond to the rectangular opening formed by support 3 and anvil 4 and whose interior shape constitutes the semi-circular or round opening. This insert is then positioned or removed depending on the section to be cut.

The cutting tool furthermore has first lever 7 and second lever 8 making it possible both to grasp the tool and to make blade 2 move from the open position to the closed position. First lever 7 is mounted so as to pivot in support 3 around shaft 9 transverse to the longitudinal extent of the tool, and it cooperates with blade 2 for the movement of it from open position to closed position, while second lever 8, oriented perpendicular to the longitudinal extent of support 3, is mounted fixed with respect to support 3.

Blade 2 is mounted on first end 11 of rack 10 with longitudinal axis 13 extending between first end 11 and second end 12 of the rack. Rack 10 is mounted so as to slide in calibrated guide means 6 and sticks out from support 3, on the opposite side with respect to blade 2, by second end 12 where it is provided with handle 14 enabling one to turn rack 10 around its longitudinal axis 13 between an active position allowing rack 10 to cooperate with first lever 7 in order to move blade 2 from the open position to the closed position, and a passive position enabling one to move blade 2 from the closed position to the open position. Second end 12 of the rack is also provided with holding screw 15 forming a stop during translation of the rack. This stop is used, on one hand, as limiter of the course of travel of the blade when it is moved to the closed position, and on the other hand, for preventing the blade, together with the rack, from accidentally coming out of calibrated guide 6.

Blade 2 is provided with two successive cutting edges 21, 22 forming peak 23 between them and giving the blade a symmetrical shape. The two cutting edges 21, 22 enclose between them an obtuse angle WL ranging from approximately 110 to 150°. The optimal angle WL for obtaining a good cutting result, without particular deformation of the section, and with an advantageous cutting speed, is on the order of 130°.

In order to facilitate beveled cutting, anvil 4 is provided with stops 41, 42 mounted in a removable manner on both sides of anvil 4 and configured so as to enable one to position the section that is to be cut under an angle WB1 or WB2, in a precise angular position with respect to the orientation of blade 2. Stops 41, 42 are advantageously screwed on anvil 4.

According to an execution variant not represented in the drawings, stops 41, 42 are screwed on base 1.

According to another execution variant, the stops are attached permanently on base 1 or on anvil 4, for example, using rivets. However, such an execution deprives the user of the possibility of preparing the tool according to his needs for different angles for which stops can be provided with the tool. Permanent or definitive attachment of the stops could in contrast be chosen for a very inexpensive version of the tool.

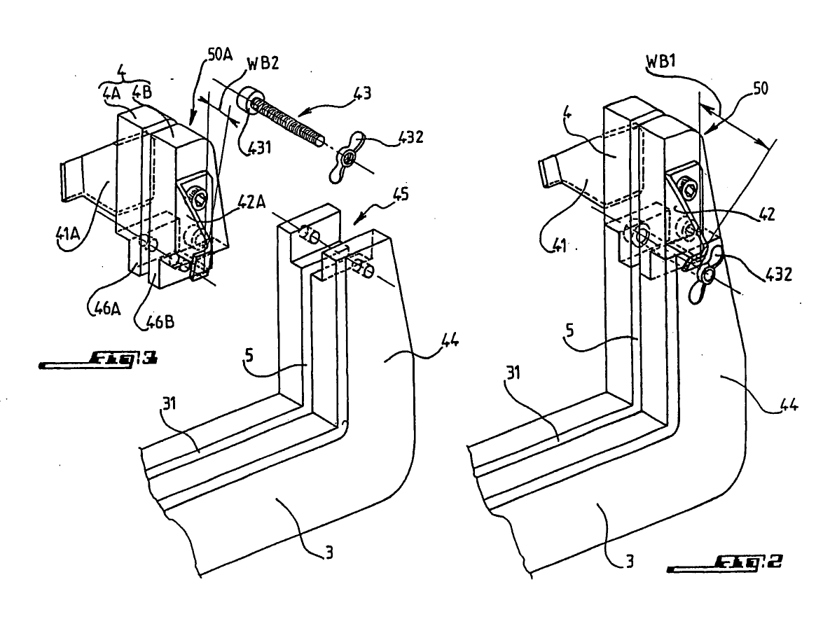

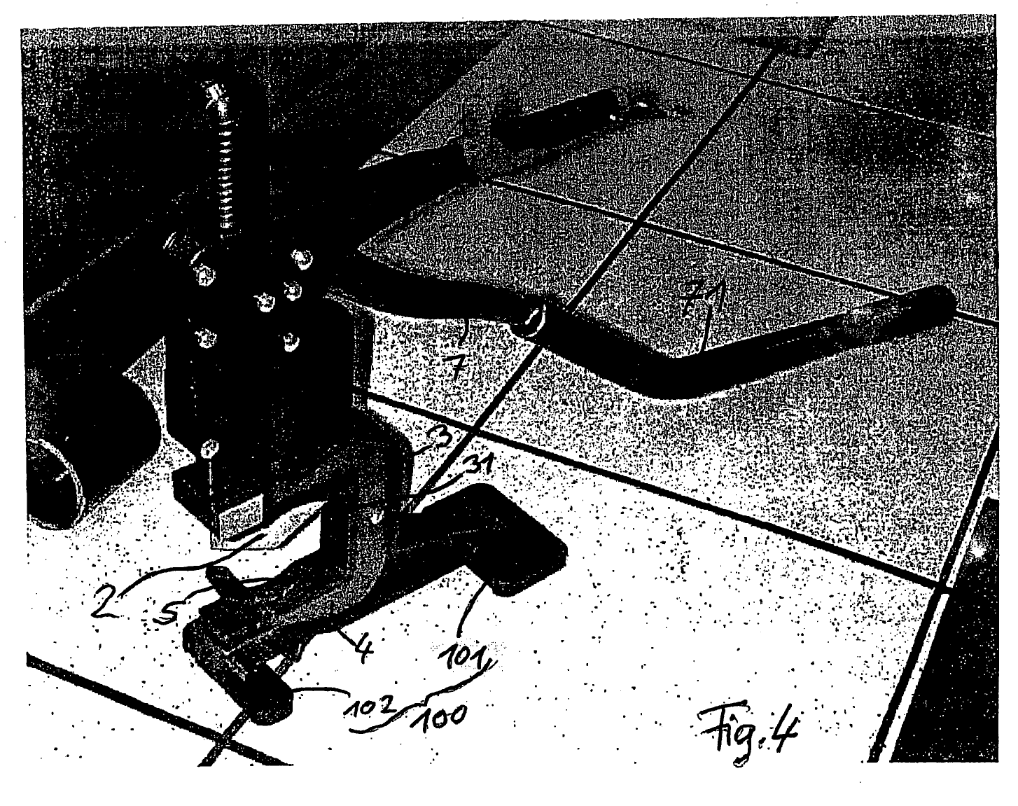

According to yet another execution variant, which is represented in FIGS. 2 and 3, anvil 4 is formed by two interchangeable pieces 4A and 4B separated by groove 5, which in this case is in the form of a slot passing entirely through the anvil. Pieces 4A and 4B respectively bear stop 41 and stop 42 and with them form removable unit 50 with a bevel angle WB1 oriented respectively toward one side or the other of the anvil. Pieces 4A and 4B are partially extended so that together they form tenon 46A, 46B intended for insertion in notch or mortise 45 made in rear part 44 of the anvil. Tenon 46A, 46B and mortise 45 can have a right-angled shape or a dovetailed shape.

Removable unit 50 can be present with other bevel angles, for example, bevel angle WB2. This unit is referenced 50A.

In one case as in the other, removable unit 50 or 50A is advantageously attached on rear part 44 of the anvil by bolt 43 formed by screw 431 and wing nut 432 making rapid removal of the bolt possible without tools.

For the attachment of the tool on a table or work bench, base 1 is advantageously provided with perforations 61, 62 making it possible to attach the tool using screws or bolts.

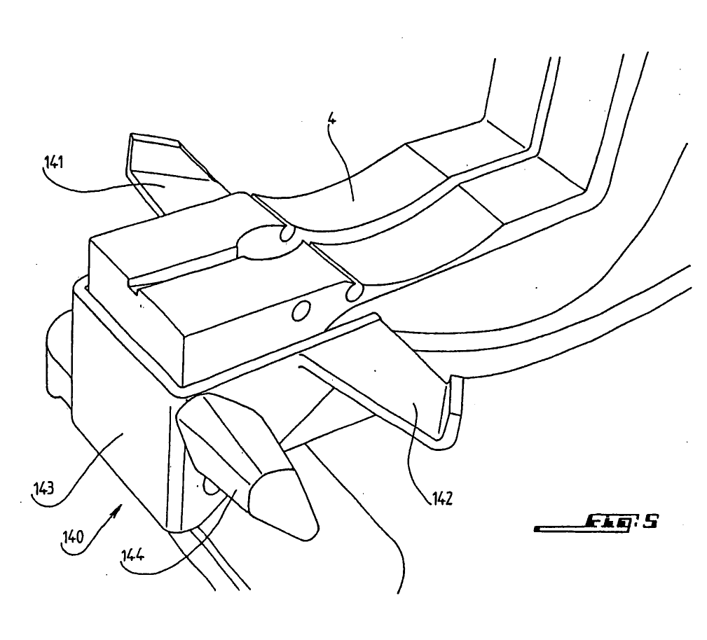

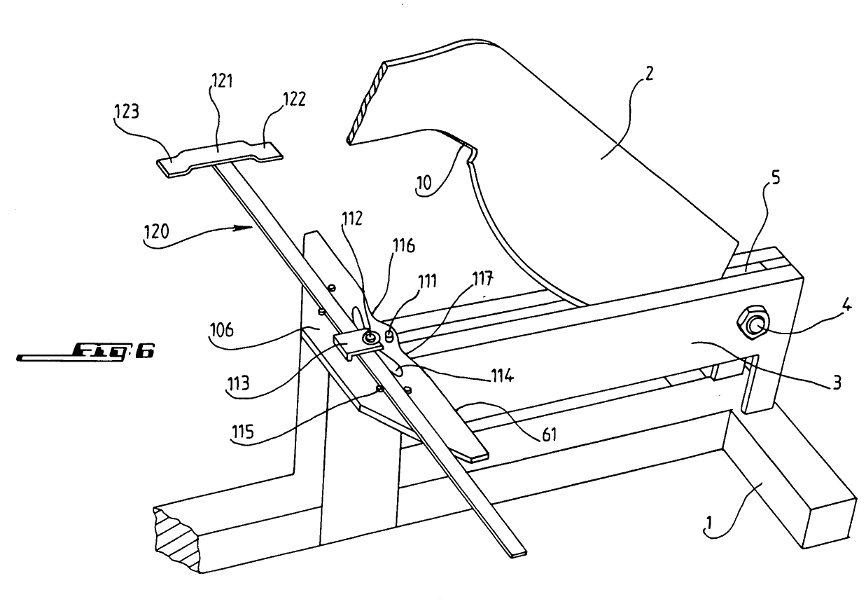

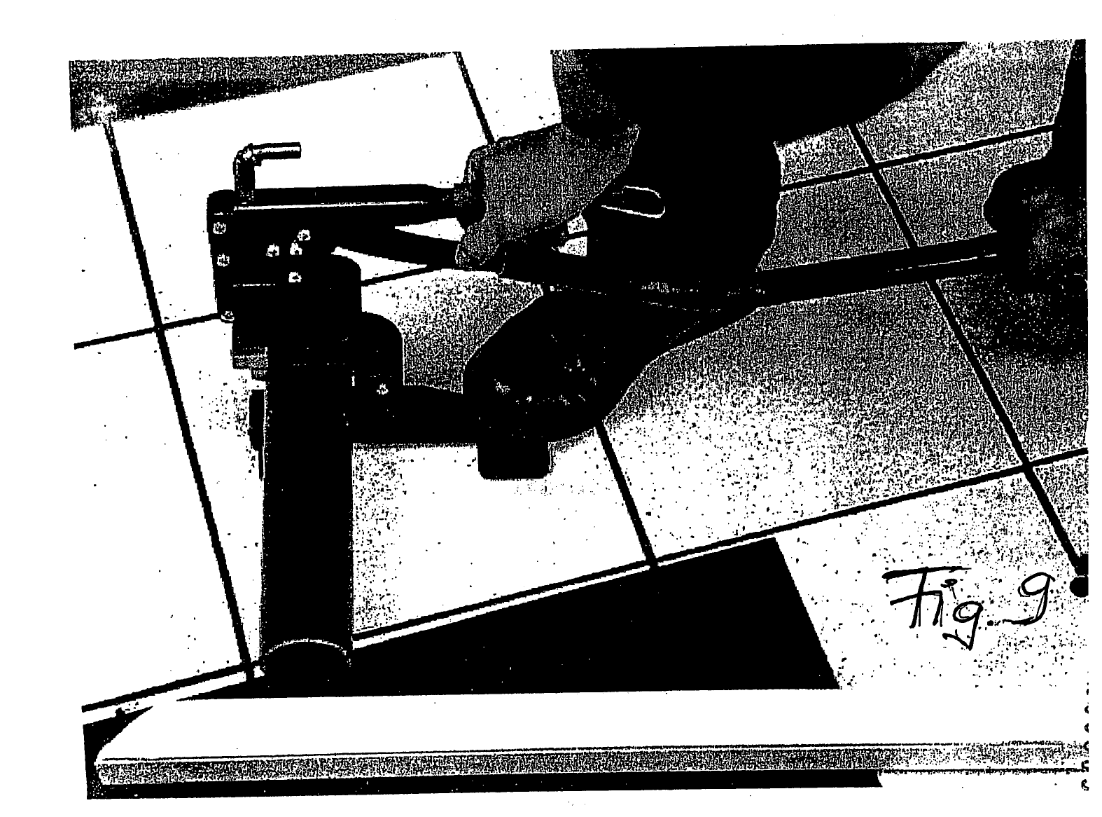

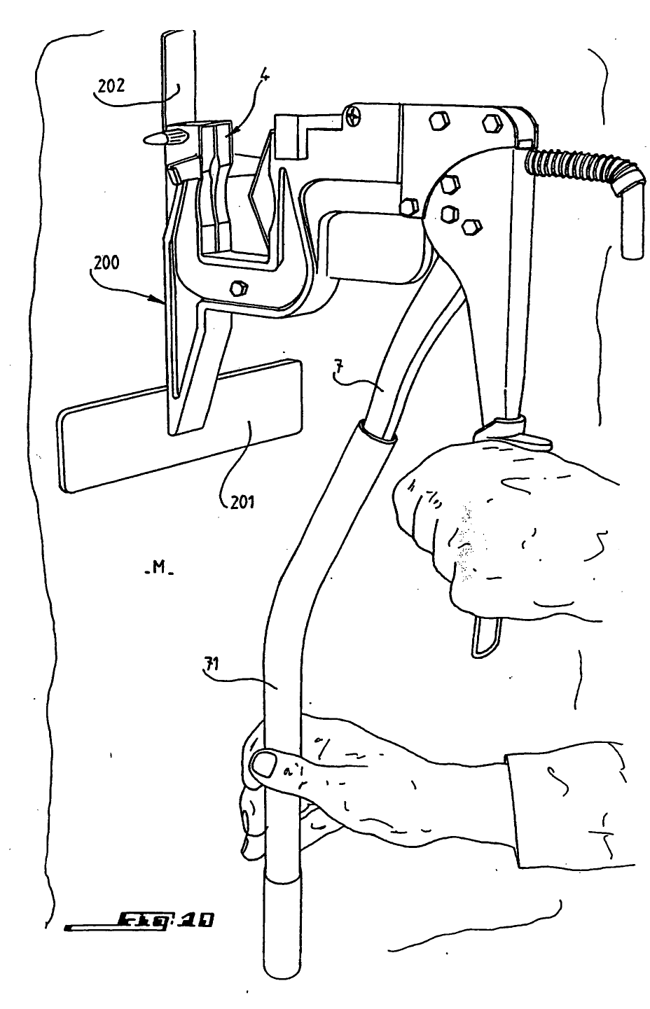

The cutting tool according to the second embodiment of the invention, as represented in FIG. 4, has essentially the same pieces and elements as the tool of FIG. 1. For this reason, the pieces and elements of the two embodiments of the tool of the invention bear the same references in the drawings. Thus, the tool represented in FIGS. 4 and 9 in entirety and in FIGS. 5 to 8 by a few details, has “H”-shaped base 100 with two crosspieces 101, 102, and blade 2 mounted so as to be mobile on structure or support 3 attached to base 1 and enabling one to move blade 2 in axial translation between an open position for receiving, between base 100 and blade 2, a section that is to be cut, and a closed position at the end of a cutting operation. Since blade 2 of the second embodiment has the same characteristics as that of the first embodiment, repetition of these characteristics is omitted here.

Base 100 supports anvil 4 provided with groove 5 configured for receiving a part of blade 2 when it is in closed position. Support 3 is provided with calibrated guide means 6 (see FIG. 1) in the form of a hollow cylindrical insert ensuring a linear movement of blade 2 between the open position and the closed position. Support 3 also has groove 31 oriented in the direction of the translations of blade 2. Groove 31 receives, in a sliding manner, a corresponding edge of blade 2 during its movements in order to prevent any effect of rotation of blade 2 around its own longitudinal axis.

The cutting tool furthermore has first lever 7 and second lever 8 making it possible both to grasp the tool and to make blade 2 move from the open position to the closed position. First lever 7 is mounted so as to pivot in support 3 around shaft 9 (see FIG. 1) transverse to the longitudinal extent of the tool and to cooperate with blade 2 for the movement of it from open position to closed position, while second lever 8, oriented perpendicular to the longitudinal extent of support 3, is mounted fixed with respect to support 3.

When the cutting tool is arranged for cutting a section with medium dimensions, for example, diameters or widths on the order of 40-70 mm, first lever 7 can be equipped with removable tubular extension 71 in order to gear down its lever arm. According to the execution represented in FIGS. 4 and 9, lever 7 nests in tubular extension 71. However, other types of extended lever are also conceivable: according to a variant not represented in the drawings, first lever 7 can be executed in the form of a retractable lever arm in the form of two or more parts connected together by hinges so that it is possible to fold the lever over itself during transport of the tool or when the tool is being stored.

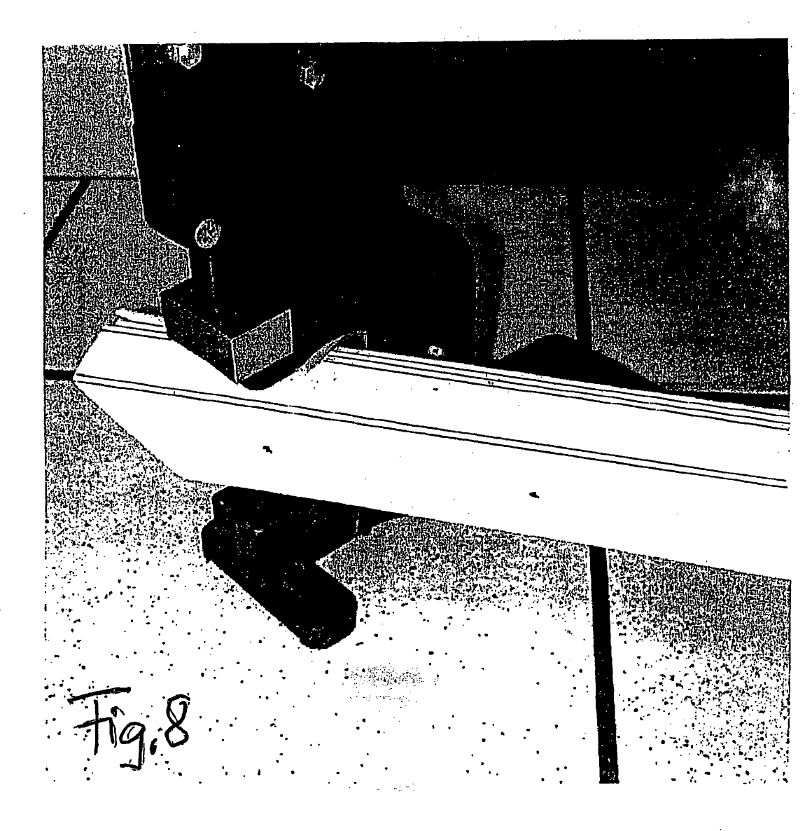

Blade 2 is mounted in a first end of rack 110 shown in detail in FIG. 7. Rack 110, which has a second curved end 111, is mounted so as to slide in calibrated guide means 6 and sticks out from support 3, on the opposite side with respect to blade 2, by second end 111, which is provided with return spring 112 and which forms a handle enabling one to turn rack 110 around its longitudinal axis between an active position allowing rack 110 to cooperate with first lever 7 in order to move blade 2 from the open position to the closed position, and a passive position making it possible to move blade 2, under the action of return spring 112, from the closed position to the open position.

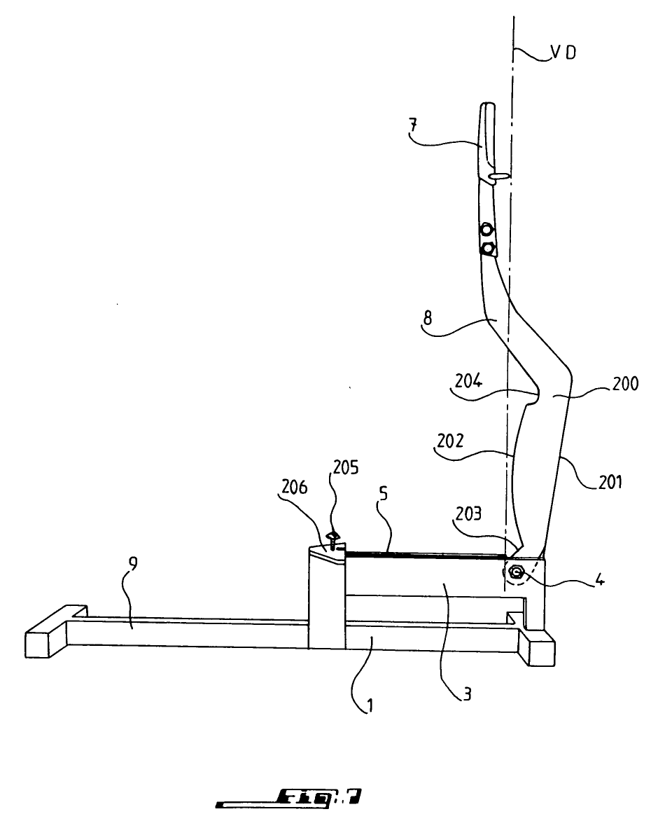

In order to facilitate beveled cutting, anvil 4 is provided with stops 141, 142 connected together by “U”-shaped piece 143. Stops 141, 142 and piece 143 form removable unit 140 mounted in a removable manner on anvil 4 and configured so as to enable one to position the section that is to be cut in a precise angular position with respect to the orientation of blade 2. Each of stops 141, 142 is advantageously provided with oblong hole 144 enabling one to attach stop unit 140 in at least two different positions by screwing using bolt 43 (see also FIG. 3), a retracted position represented in FIG. 5, and a work position represented in FIG. 6, without the need to undo the attachment entirely.

FIG. 10 shows a variant of the tool according to the second embodiment of the invention. According to this variant, the tool has tripod base 200 instead of a base provided with two crosspieces. Tripod base 200 can also be applied to a tool executed according to the first embodiment of the invention.

Tripod base 200 has crosspiece 201 oriented essentially perpendicular to the orientation of blade 2 and extension 202 extending according to the orientation of blade 2, crosspiece 201 being arranged on the side of levers 7, 8 of the tool and extension 202 extending beyond anvil 4 away from crosspiece 201. The advantage of tripod base 200 with respect to “H”-shaped base 100 is better stability during cutting, because in the direction of pivoting of first lever 7 during cutting, particularly in the case of gearing down by extension 71, the forces exerted on the tool are greater to the front of the tool than to the rear, which promotes rocking of the tool toward the front.

FIG. 10 shows that it is also possible to use the tool of the invention, regardless of its method of execution, in vertical position, that is to say resting against wall M. In this position, the tool will advantageously be attached to the wall by nails or screws. However, the tool can also be used free, that is to say without attaching it to wall M.

1. A cutting tool for cutting hollow plastic sections, base comprising:
a support;
a blade movable on the support and attached to the base, the blade being movable between an open position for receiving, between the base and the blade, a section that is to be cut, and a closed position after a cutting operation;
an anvil supported by the base and including a groove receiving a part of the blade when the blade is in closed position; and
calibrated guide means on the support for ensuring linear movement of the blade between the open position and the closed position.

2. The tool according to claim 1, including:
at least one first lever pivotally mounted on the support and cooperating with the blade for movement of the blade from the open position to the closed position; and
a rack with a longitudinal axis, wherein
the blade is mounted on a first end of the rack,
the rack slides in the calibrated guide means and protrudes from the support on a side opposite the blade, at a second end of the rack, regardless of position of the blade, and
the rack is activated by the first lever.

3. The tool according to claim 1, including a first lever and a second lever articulated together on a pivot shaft for grasping the cutting tool and moving the blade from the open position to the closed position.

4. The tool according to claim 3, wherein the first lever pivots with respect to the second lever and the support, and the second lever is fixed with respect to support.

5. (canceled)

6. The tool according to claim 2, wherein the second end of the rack includes a handle turning the rack around the longitudinal axis, between an active position, in which the rack cooperates with the first lever to move the blade from the open position to the closed position, and a passive position, in which the blade may be moved from the closed position to the open position.

7. The tool according to claim 1, wherein the blade includes two intersecting cutting edges forming a point and an internal obtuse angle ranging from approximately 110°-150°.

8. The tool according to claim 1, wherein the blade has a symmetrical shape.

9. The tool according to claim 1, wherein the base includes stops mounted on opposite sides of the base and for positioning a section to be cut in an angular position with respect to the blade to produce a beveled edge on the section.

10. The tool according to claim 1, wherein the anvil includes stops located on opposite sides of the base for positioning a section to be cut in an angular position with respect to the blade to produce a beveled edge on the section, the anvil and the stops being a removable unit configured for a specific bevel angle and interchangeable with other interchangeable units configured for other specific bevel angles.
